(19) United States
(12) Patent Application Publication
(10) Pub. No.: US 2022/0214702 A1
(43) Pub. Date: Jul. 7, 2022

(54) SYSTEMS AND METHODS ENABLING EVASIVE UAV MOVEMENTS DURING HOVER AND FLIGHT

(71) Applicants: LUIS M. ORTIZ, Albuquerque, NM (US); Kevin H. Tsosie, Albuquerque, NM (US)

(72) Inventors: LUIS M. ORTIZ, Albuquerque, NM (US); Kevin H. Tsosie, Albuquerque, NM (US)

(21) Appl. No.: 17/513,656

(22) Filed: Oct. 28, 2021

Related U.S. Application Data
(60) Provisional application No. 63/107,306, filed on Oct. 29, 2020.

(51) Int. Cl. G05D 1/10; G05D 1/00; B64C 39/02; B64D 47/08

(52) U.S. Cl. CPC G05D 1/106; G05D 1/0011; B64C 39/024; B64C 2201/127; B64C 2201/027; B64C 2201/146; B64D 47/08

(57) ABSTRACT

Systems and methods enable a determination as to whether a UAV is hovering at a surveillance location and can engage evasive hovering movements while UAV is engaged in surveillance at the surveillance location. Evasive hovering movement can be restricted to a define space at the UAV's hover location. Engagement of evasive hovering movements can be from a remote controller. A camera can maintain lock on a surveilled target during evasive hovering movements. A laser can maintain lock on a surveilled target during evasive hovering movements. Evasive movements can also be implemented during UAV forward flight.

### INVENTION PRIORITY

The present embodiments are filed as a nonprovisional application and as a continuation of provisional patent application Ser. No. 63/107,306 entitled “SYSTEMS AND METHODS ENABLING EVASIVE UAV MOVEMENTS DURING HOVER AND FLIGHT” filed Oct. 29, 2020, which is hereby incorporated by reference.

### TECHNICAL FIELD

Embodiments of the present invention are generally related to unmanned aerial vehicles (“UAVs”) and their performance during flight. More particularly, embodiments of the present invention are related to systems and method enabling evasive movement of unmanned aerial vehicles during hover and flight operations to avoid contact from hostile sources.

### BACKGROUND

Unmanned aerial vehicles (“UAVs”), also often referred to as “drones”, have grown in popularity and use in the past decade. UAVs can cost as little as a few hundred dollars on up to millions of dollars in the United States. UAV navigation and data gathering capabilities are robust and they are becoming an important tool. UAVs can take photographs, acquire video, employ detection sensors, deploy pesticides over farmland, and deliver packages to consumers.

The use of UAVs is growing in a variety of government, commercial and private uses. Federal and state governments are utilizing drones for surveillance and detection along border and at points of interest. UAVs will find numerous uses in military and law enforcement activities. Commercial enterprises also utilize drones for surveillance, mapping, and delivery. Private uses of UAVs are more restricted to personal enjoyment and photography. U.S. Pat. No. 10,313,638 issued to Amazon Technologies, Inc., incorporated herein by reference for its general teaching about UAVs, teaches the use of a UAV for two simultaneous purposes, package deliveries as well as security surveillance.

Regardless of their type and use, UAVs are becoming more susceptible to undergoing hostile action. During flight or when hovering, for example, UAVs can be targeted by small arms fire and disabled. This scenario would be likely where suspicious ground operations (e.g., burglary, illegal border crossings) are being monitored by UAVs while in flight or while hovering near the suspicious activity. An assailant armed with a rifle can easily target and shoot down a UAV while it is hovering and acquiring video footage of the surveilled activity. What is needed are means to protect UAVs from being easily targeted and disabled by hostile ground-based acts such as projectiles being shot from small arms.

### SUMMARY

The embodiments disclosed herein address the need to protect UAVs from being easily targeted and disabled by hostile ground-based acts, such as projectile fired from a rifle or gun.

It is a feature of the embodiments to include programming in the navigational operations module of a UAV to enable the UAV to hover in a randomized pattern (up, down, right, left, back, forth, horizontally, etc.) in order to evade hostility, e.g., to make it more difficult for a ground-based hostile to target the UAV with small arms fire and short it down.

It is another feature of the embodiments to include programming in the navigation operations module of a UAV to enable the UAV to fly forward in a randomized fashion (up, down, left right, etc.) in order to evade hostility, e.g., to make it more difficult for a ground-based hostile to target the UAV with small arms fire and short it down.

It is another feature of the embodiments to enable a UAVs camera to remain locked on a target while the UAV is performing evasive movement.

It is yet another feature of the embodiments to enable a UAV to employ a laser to lase a target, and maintain a lock on the target by the laser while the UAV is performing evasive movement.

### BRIEF DESCRIPTION OF DRAWINGS

FIG. 1 illustrates a block diagram of components for a UAV in accordance with features of the embodiments.

FIG. 2 illustrates a block diagram of sample UAV movements that can caused by programming in a drone's navigational operations module during hovering.

FIG. 3 illustrates a block diagram of sample UAV movements that can caused by programming in a drone's navigational operations module during forward movement.

FIG. 4 illustrates a flow diagram of method steps that can be followed to cause randomized movement of a UAV during hovering.

FIG. 5 illustrates a flow diagram of method steps that can be followed to cause randomized movement of a UAV during forward movement.

FIG. 6 illustrates a flow diagram of method steps that can be followed to cause randomized movement of a UAV during forward movement and maintain image lock on a target by a camera associated with the UAV while the UAV is taking evasive action.

FIG. 7 illustrates a flow diagram of method steps that can be followed to cause randomized movement of a UAV during forward movement and maintain laser lock on a target by a laser associated with the UAV while the UAV is taking evasive action.

FIG. 8 illustrates is an example land plot with an example premises thereon and surrounding artifacts whereabout the UAV can be dedicated as security and can be trained to identify objects surrounding the particular premises, e.g., trees, poles, overhead wiring, cars, etc.

FIG. 9 illustrates a platform, docking station or housing wherein a UAV in accordance with the embodiments can be deployed from and engage in surveillance, and from where a high frequency audible signal can be emitted to warn nearby birds of the UAV presence/launch and allow the birds to clear the area.

### DETAILED DECRIPTION

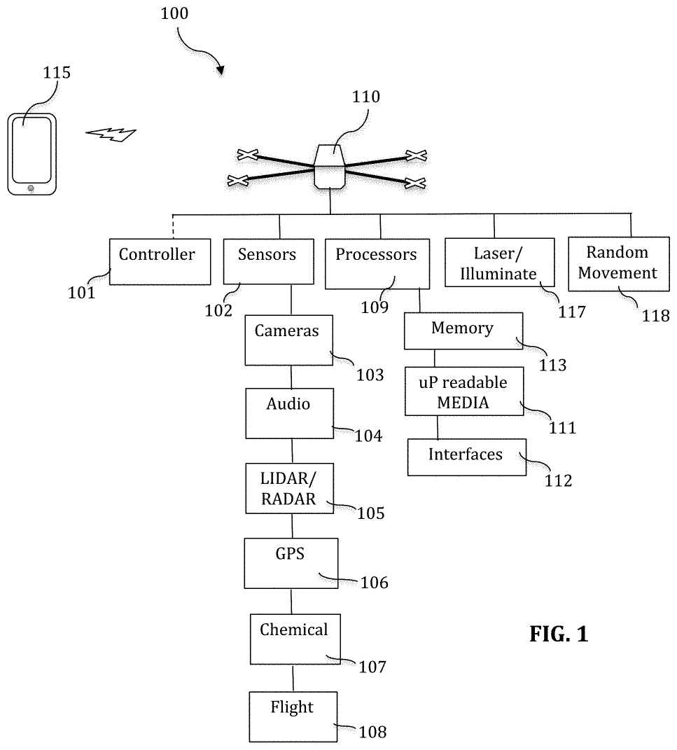

Referring to FIG. 1, illustrated is a block diagram 100 of components for a UAV 110 in accordance with features of the embodiments. A UAV 110 can be is supported by a central controller 101. The controller can include at least one microprocessor and all computing and software processing operations required for UAV operation. The UAV 110 can be equipped with sensors 102 that perform surveillance actions, and monitor the operation and functionality of the physical structures and the physical systems of the UAV 110. In some embodiments, the sensors 102 can gather surveillance data during a surveillance action of a premises or perimeter. The sensors 102 can include, but are not limited to, digital camera(s) 103, including spectral camera(s). Sensor 102 can also include audio sensor(s) 104, LIDAR/RADAR 105, global positioning system (GPS) sensor(s) 106, chemical sensor(s) 107, and flight sensor(s) 108.

In various embodiments, a digital camera(s) 103 can be used to provide imaging input for the UAV 110 during flight, hovering, and/or during a surveillance action. For example, the digital camera(s) 102 can be used to provide real time still images or real time video of a surveillance location. In some embodiments, the digital camera(s) 103 can include stereoscopic cameras with varying focal lengths to provide three dimensional images. For example, when viewing a stereoscopic image produced by the digital camera(s) 103, the portions of an image closer to the digital camera(s) 103 can be in focus, while the portions of the image further away from the digital camera(s) 103 can be blurry. In some embodiments, the digital camera(s) 103 can be used for machine vision, navigation, etc.

In some embodiments, the spectral camera(s) can be provided at part of the sensors 102 and digital cameras 102 for infrared imaging, near-infrared imaging, thermal imaging, and/or night vision imaging. In some embodiments, the spectral camera(s) can provide still images and/or video imaging capabilities. In some embodiments, the spectral camera(s) and/or the digital camera(s) 103 can be used together to provide multi-dimensional (and/or multi-layered) surveillance images representing a variety of light spectrums. For example, a surveillance action can use the digital camera(s) 103 to identify a broken window at a surveillance location, and the spectral camera(s) can be used to identify a person inside of a building, while combining the data into a multi-dimensional or multi-layered image. In some embodiments, the spectral camera(s) can be used to provide a thermal image of a building, for example, to determine the energy efficiency of the building.

In some embodiments, the audio sensor(s) 104 can be used to detect noise at a surveillance location. The audio sensor(s) 104 may include filters and/or audio processing to compensate for noise generated by the UAV 110.

LIDAR/RADAR 105 (laser illuminated detection and ranging/radio detection and ranging) can provide detection, identification, and precision measurement of a distance to a surveillance target. For example, the LIDAR/RADAR 105 can provide accurate mapping of a surveillance location, and/or determination of the location of an object of interest. In some embodiments, a LIDAR/RADAR 105 may be used in part to determine the location of the UAV 110 relative to a geo-fence. In various embodiments, the LIDAR/RADAR may be used to provide navigation of the UAV 110, in conjunction with other of the sensors 102.

In some embodiments, the global positioning system (GPS) sensor(s) 106 can provide location and time information to the UAV 110. For example, the GPS sensor(s) 106 can provide metadata to the digital camera(s) 103 and the spectral camera(s) as the location of the UAV when an image is generated. In some embodiments, the GPS sensor(s) 106 can be used in generating geo-clipped surveillance data, such as a geo-clipped image or video.

In some embodiments, the chemical sensor(s) 107 can be used to measure the presence of various chemicals in the air. For example, the chemical sensor(s) can be used to detect chemicals to determine the presence fire, or may be used to detect a chemical leak.

In some embodiments, the flight/delivery sensor(s) 108 can include accelerometer(s), gyroscope(s), proximity sensor(s), temperature sensor(s), moisture sensor(s), voltage sensor(s), current sensor(s), and strain gauge(s). In some embodiments, the flight/delivery sensor(s) 108 can provide support to the UAV 110 physical systems. In some embodiments, data from the flight/delivery sensor(s) 110 may be used in conjunction with surveillance data, for example, in generating geo-clipped surveillance data.

In some embodiments, the UAV 110 can include one or more processor(s) 109 operably connected to computer-readable media 111. The UAV 110 can also include one or more interfaces 112 to enable communication between the UAV 110 and other networked devices, such as the central or remote controller 115, a surveillance location, a service provider, a user device, or other UAVs. The one or more interfaces 112 can include network interface controllers (NICs), I/O interfaces, or other types of transceiver devices to send and receive communications over a network. For simplicity, other computers are omitted from the illustrated UAV 110.

The computer-readable media 111 can include memory 113 (such as RAM), non-volatile memory, and/or non-removable memory, implemented in any method or technology for storage of information, such as computer-readable instructions, data structures, program modules, or other data. Some examples of storage media that may be included in the computer-readable media include, but are not limited to, random access memory (RAM), read only memory (ROM), electrically erasable programmable read only memory (EEPROM), flash memory or other memory technology, compact disk (CD-ROM), digital versatile disks (DVD) or other optical storage, magnetic cassettes, magnetic tape, magnetic disk storage or other magnetic storage devices, or any other medium which can be used to store the desired information and which can be accessed by a computing device.

In some embodiments, the processor(s) 109 and the computer readable media 111 can correspond to the processor(s) 109 and computer-readable media 111 associated with the central controller 101. The computer-readable media 111 can include an operating system in memory 113. The memory 113 can be used to locally store sensor data that corresponds to the sensor 102 data. As non-limiting examples, the memory 113 can store surveillance data, data relating to delivery actions and surveillance actions, and scheduling information. In some embodiments.

In some embodiments the UAV 110 can include laser/illumination 117 capabilities. A laser can be used to acquire and illuminate a target under surveillance.

The UAV 110 can include a random movement module 118. The random movement module 118 can control movement of the UAV 110 as it performs surveillance actions. In some embodiments, the random movement module 118 can receive sensor data from the sensors 102 and can modify the UAV's movement. In some embodiments, the random movement module 118 can include a machine vision algorithm that registers surveillance data, determines the probability of a hostile event (e.g., rifle pointed at UAV), and can generate one or more randomized movements in response to the hostile event.

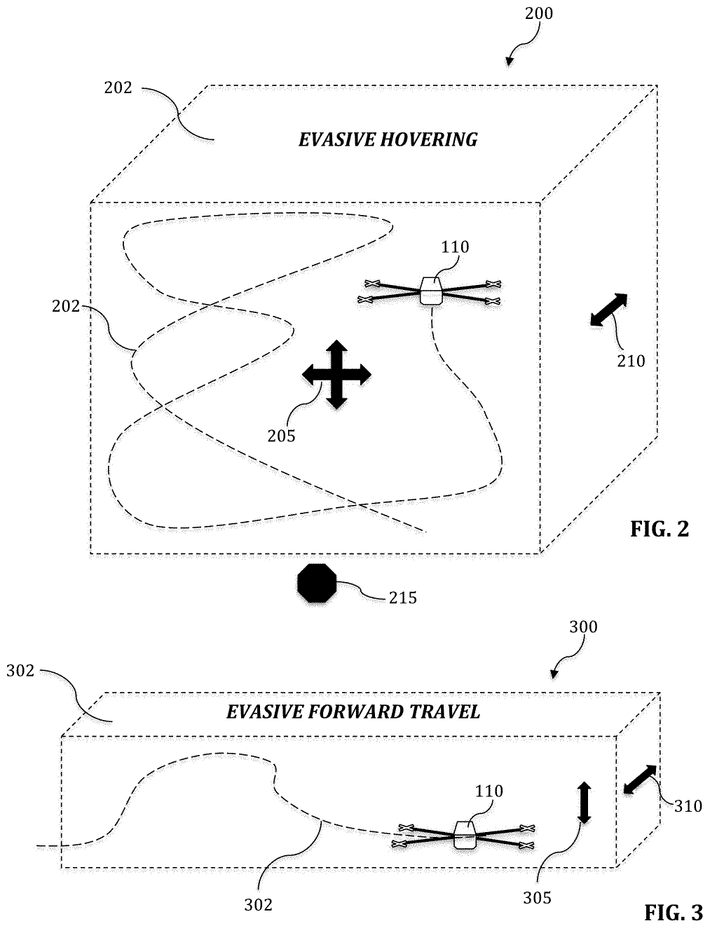

Referring to FIG. 2, illustrated is a block diagram 200 of sample UAV 110 movements 202 that can be caused by programming of a UAV's navigational operations via the random movement module 118 during hovering. Random variations in altitude and orientation 205 and distance 210 with respect to a surveilled target 215 can be implemented during hovering operations. Randomization in, for example, yaw, pitch, roll will ensure that the same pattern is not followed by the UAV 110. A UAV 110 can appear to be engaged in motions 202 that are zig-zagging, or moving away and closer to the surveilled activity 215. Motions can be up-down, right-left, as shown by arrows 205, or forward-backward as shown by arrow 210, in a randomized fashion, and all movement can also be restricted to a virtual space 202 (e.g., shown as a box) within the UAVs 110 surrounding airspace with respect to the target 215. Randomized motions will make it increasingly more difficult for a hostile actor on the ground to target the UAV 210, and possibly shoot it down or damage it. This can be referred to as “evasive hovering” or evasive maneuvering for UAVs.

Referring to FIG. 3, illustrated is a block diagram 300 of sample UAV 110 movements that can caused by programming in a UAV's navigational operations via the random movement module 118 during forward movement. The UAV 110 can be programmed with flight patterns that randomly move the UAV 110 up/down as shown by arrow 305, and left/right as shown by arrow 310, within its flight plan 302 that make it difficult for the UAV to be targeted or damaged during forward travel. This can be referred to as “evasive forward travel” for UAVs.

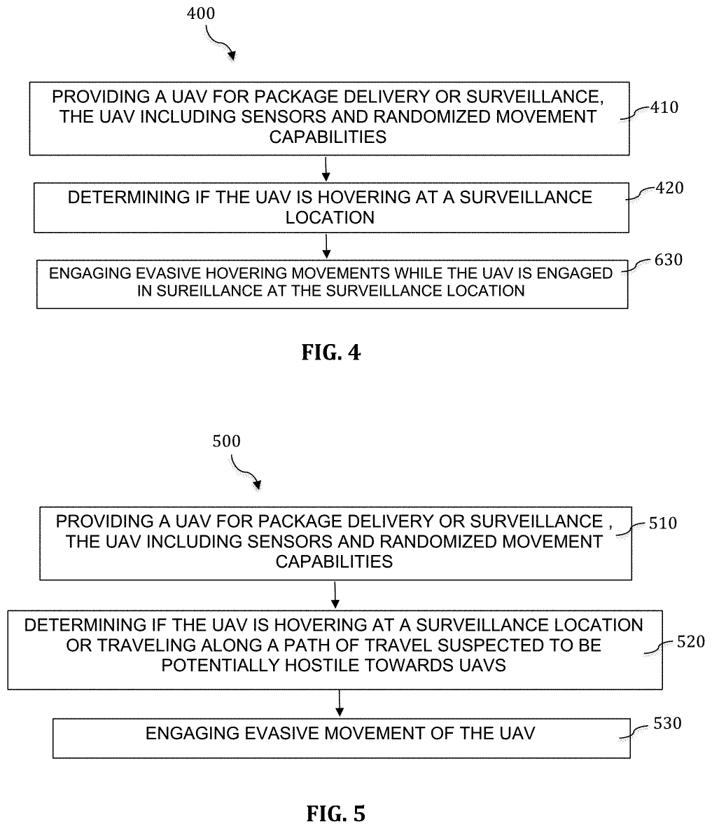

Referring to FIG. 4, illustrated is a flow diagram 400 of method steps that can be followed to cause randomized movement of a UAV during hovering. As shown in Block 410, a UAV including a camera and randomized movement capabilities can be provided for package delivery and/or surveillance. As shown in Block 420, it can be determined if the UAV is hovering at a surveillance location. Then, as shown in Block 430, the UAV engages in evasive hovering movements while the UAV is engaged in surveillance at the surveillance location.

Referring to FIG. 5, illustrated is a flow diagram of method steps that can be followed to cause randomized movement of a UAV including sensors and randomized movement operations during hovering or forward movement. As shown in Block 510, a UAV including sensors and randomized movement capabilities can be provided for package deliver and/or surveillance operations. As shown in Block 520, it can be determined if the UA is hovering at a surveillance location or traveling along a path of travel suspected to e potentially hostile towards UAVs. Then, as shown in Block 530, the UAV engages in evasive movements.

With UAV movement, it is preferred that an on-board camera 103 be able to maintain its lock and focus on surveilled targets 215. Image processing algorithms can be implemented to maintain lock and focus on surveilled targets 215 (whether stationary or moving) during UAV flight and and while in hover mode where randomized UAV movement is being performed for the purpose of taking evasive action. An on-board camera 103 can automatically focus on the surveilled targets 215 during UAV movement and reduce distortion of acquired images/video. A camera 103 can maintain a lock on a target 215 (or subject of interest) during UAV maneuvering 202. The target is the “point of interest” (or POI). Active target tracking capabilities can be implemented while the UAV 110 is undergoing evasive movements during hovering and during surveillance.

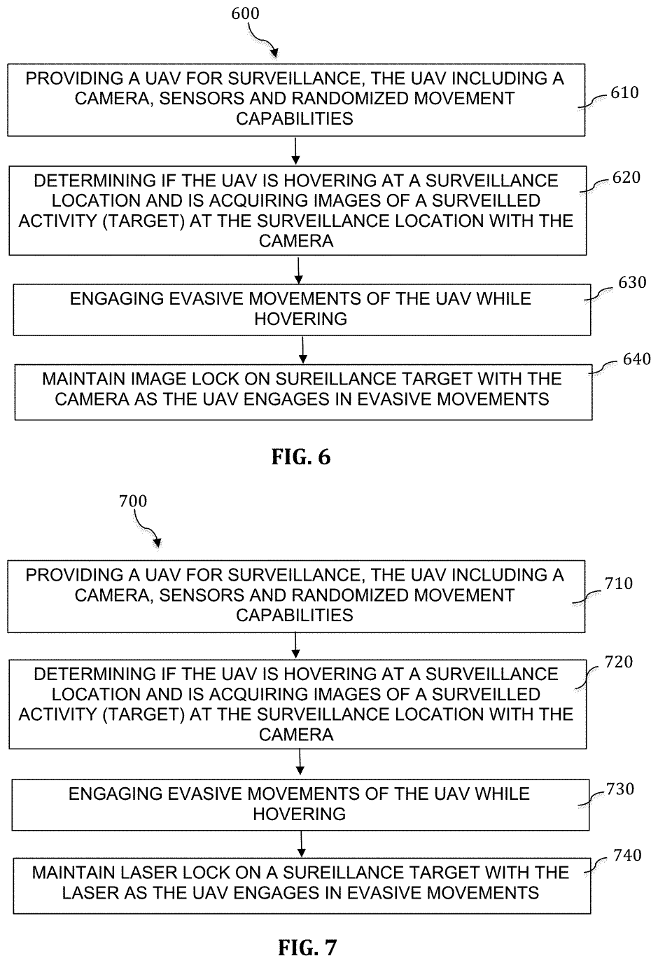

Referring to FIG. 6, illustrated is a flow diagram of method steps that can be followed to cause randomized movement of a UAV during hovering or forward movement and maintain image lock on a target by a camera 103 associated with the UAV 110 while the UAV 110 is taking evasive action. As shown in Block 610, a UAV including a camera, sensors and randomized movement operations can be provided for surveillance operations. As shown in Block 620, it can be determined if the UAV is hovering at a surveillance location and if it is acquiring images of a surveilled activity (or target) at the surveillance location with the camera. As shown in Block 630, the UAV engages in evasive movements while hovering. Then, a camera maintains image lock on the surveillance target as the UAV engages in the evasive movements, as shown in Block 640.

Referring to FIG. 7, illustrated is a flow diagram of method steps that can be followed to cause randomized movement of a UAV during hovering operations and also maintain laser lock on a target by a laser associated with the UAV while the UAV is engaged in evasive action. Image processing can assist in maintaining laser lock on a subject/target using real-time images being captured by the UAV camera to adjust the lasers direction and maintain the laser's illumination of the target. As shown in Block 710, a UAV including a camera, a laser, sensors and randomized movement capabilities can be provided for surveillance. It can be determined if the UAV is hovering at a surveillance location and is acquiring images of a surveilled activity (Target) at to surveillance location with the camera, as shown in Block 720. As shown in Block 730, the UAV can engage in evasive movements while hovering. The, as shown in Block 740, the UAV can maintain laser lock on a surveillance target with the laser as the UAV engaged in the evasive movements. When a red dot laser light can be focused on a surveilled target it can have a deterrent effect on the target. If a ground-based target is human and the target is being lased by the UAV, the lasing may encourage the target to abandon his/er illegal effort at a surveilled premises.

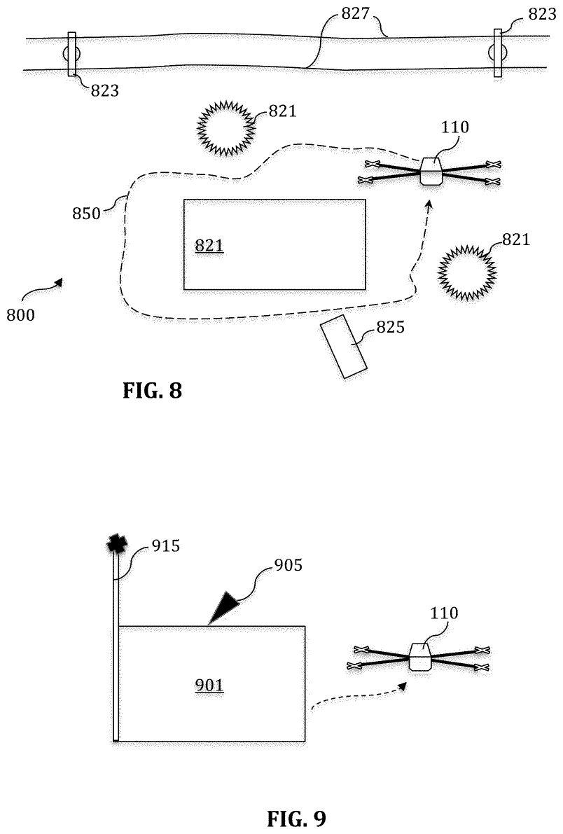

Referring to FIG. 8, illustrated is an example land plot 800 with an example premises 820 and surrounding artifacts. In applications where the UAV 110 is dedicated as security for a particular premises 820 , the UAV 110 can be trained to identify objects surrounding the particular premises, e.g., trees 821, poles 823, overhead wiring 825, cars 827. These objects can be taken into account when the UAV 110 during surveillance and also when it is engaged in randomized movements during its hovering mode. Familiarization of dedicated premises surroundings can ensure that the drone can follow a familiar path 850 and not become disabled during flight and hovering by running into objects.

Referring to FIG. 9, in dedicated applications, when a UAV 110 initially becomes activated to lift-off from its platform, docking station or housing 901 and engage in surveillance, it can be programmed to emit a high frequency audible signal from its audio module 104 to warn nearby birds of the UAV presence/launch and allow the birds to clear the area. The audio signal can also come from a speaker associated with the launch pad or the UAV 110, as shown in FIG. 9. Also in dedicated premises applications, a anemometer 915 can be associated with the UAVs docking platform/station/housing 901, in order to determine if the UAV 110 can safely launch are navigate around the premises 821. If wind is above a safe threshold, the UAV 110 does not have to deploy. Finally, in a dedicated premises application, a UAV 110 can launch on a schedule (between charging operations) to surveille around the dedicated premises. The UAV can continue to acquire images for comparison with past surveillance and can “further investigate” a particular area of a dedicated premises if an anomaly is detected (e.g., people or vehicles detected in locations not previously occupied).

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method, comprising:
determining if a UAV is hovering at a surveillance location; and
engaging evasive hovering movements while UAV is engaged in surveillance at the surveillance location.

2. The Method of claim 1, wherein the evasive hovering movements include randomized movements in several directions including at least four of: up, down, right, left, forward, backward, horizontal left to right, horizontal right to left.

3. The method of claim 1, wherein the evasive hovering movements are engaged remotely and wireless by a controller.

4. The method of claim 1, wherein evasive hovering movements are confined within a virtual space at the UAV's hover location.

5. The method of claim 2, wherein evasive hovering movements are confined within a virtual space at the UAV's hover location.

6. The Method of claim 4, wherein the evasive hovering movements include randomized movements in several directions including at least four of: up, down, right, left, forward, backward, horizontal left to right, horizontal right to left.

7. The method of claim 1, wherein a ground based target is acquired by a camera associated with the UAV and is lased by a laser associated with the UAC as the UAV is engaged in the evasive hovering movements.

8. A system comprising: one or more processors and memory coupled to the one or more processors, the memory including one or more instructions that when executed by the one or more processors, cause the one or more processors to perform acts comprising:
determining if a UAV is hovering at a surveillance location; and
engaging evasive hovering movements while UAV is engaged in surveillance at the surveillance location.

9. The system of claim 8, wherein the evasive hovering movements are engaged remotely and wireless by a controller.

10. The method of claim 8, wherein evasive hovering movements are confined within a virtual space at the UAV's hover location.

11. The method of claim 9, wherein evasive hovering movements are confined within a virtual space at the UAV's hover location.

12. The Method of claim 10, wherein the evasive hovering movements include randomized movements in several directions including at least four of: up, down, right, left, forward, backward, horizontal left to right, horizontal right to left.

13. The method of claim 12, wherein the evasive hovering movements are engaged remotely and wireless by a controller.

14. A non-transitory computer-readable medium storing instructions executable by one or more processors, wherein the instructions, when executed, cause the one or more processors to perform operations comprising:
determining if a UAV is hovering at a surveillance location; and
engaging evasive hovering movements while UAV is engaged in surveillance at the surveillance location.

15. The system of claim 14, wherein the evasive hovering movements are engaged remotely and wireless by a controller.

16. The method of claim 14, wherein evasive hovering movements are confined within a virtual space at the UAV's hover location.

17. The method of claim 15, wherein evasive hovering movements are confined within a virtual space at the UAV's hover location.

18. The Method of claim 16, wherein the evasive hovering movements include randomized movements in several directions including at least four of: up, down, right, left, forward, backward, horizontal left to right, horizontal right to left.

19. The method of claim 18, wherein the evasive hovering movements are engaged remotely and wireless by a controller.
